(19) United States
(12) Patent Application Publication
(10) Pub. No.: US 2026/0312149 A1
(43) Pub. Date: Oct. 8, 2026

(54) HIGH PERFORMANCE LFP CELL WITH ACTIVE MATERIAL COMPOSITE FOR HIGH RATE APPLICATIONS

(71) Applicant: Crimen Tech Private Limited, Thiruvananthapuram (IN)

(72) Inventors: Hari Krishnan D, Trivandrum (IN); Meghna S Nair, Pleasanton, CA (US); Bharat S I, Trivandrum (KL); Gokul G S, Trivandrum (IN)

(73) Assignee: Crimen Tech Private Limited, Thiruvananthapuram, KL (IN)

(21) Appl. No.: 19/170,987

(22) Filed: Apr. 4, 2025

(51) Int. Cl. H01M 10/42; H01M 4/04; H01M 4/131; H01M 4/133; H01M 4/1391; H01M 4/58; H01M 4/587; H01M 4/62; H01M 4/66; H01M 10/0525; H01M 10/0567; H01M 10/0568

(52) U.S. Cl. CPC H01M 10/4235; H01M 4/0404; H01M 4/131; H01M 4/133; H01M 4/1391; H01M 4/5825; H01M 4/587; H01M 4/623; H01M 4/625; H01M 4/661; H01M 4/663; H01M 4/667; H01M 10/0525; H01M 10/0567; H01M 10/0568

(57) ABSTRACT

A lithium-ion cell (100) is disclosed, comprising an anode (104) and a cathode (102) designed for enhanced electrochemical performance. The anode (104) includes an anode active material with 80-95% by weight graphite, and one or more of 5-20% by weight silicon and 5-20% by weight hard carbon. The anode (104) further comprises 2-4% by weight conductive diluents, 4-8% by weight binders, and a solvent in the range of 40-55% by weight. The cathode (102) comprises an active material composite of cathode active material (80-95% by weight) and a carbon-based conductive material (5-20% by weight). The active material composite is mixed with one or more binders, conductive diluents, and a solvent to form a slurry, which is coated onto a porous current collector. This design enhances lithium-ion diffusion pathways and electrical conductivity through uniform particle distribution and optimized electron transport, achieving a high discharge rate of 10C.

### FIELD

The present disclosure relates generally to the manufacturing of lithium-ion electrochemical cells. More particularly the present disclosure relates to manufacturing high performance lithium-ion batteries having enhanced lithium-ion diffusion pathways.

### BACKGROUND

Lithium iron phosphate (LiFePO₄ or LFP) has gained significant attention as a cathode material for lithium-ion batteries due to its high thermal stability, long cycle life, and environmental safety. However, a key limitation of LFP-based cells is their inherently low lithium-ion diffusion pathways, which restricts the movement of lithium ions within the electrode, thereby limiting high-rate discharge performance and overall electrochemical efficiency. Additionally, electrical conductivity, which governs the flow of electrons through the cathode, also plays a crucial role in battery performance.

To enhance lithium-ion diffusion pathways and electrical conductivity, researchers have traditionally employed methods such as carbon coating and the incorporation of conductive carbon-based materials like graphene, carbon nanotubes (CNTs), and conductive polymers. These approaches have demonstrated improvements in both charge transport mechanisms. Recent studies suggest that doping or coating LFP with activated carbon materials can effectively enhance its lithium-ion diffusion pathways. For instance, polypyrrole (PPy), a conductive polymer with a theoretical specific capacity of 72 mAh/g, has been shown to improve both lithium-ion diffusion pathways and electrical conductivity of LFP while also contributing to cathodic activity. Research by Jia Hai et al. (2012) and Yi-Ping Liang et al. (2013) demonstrated that PPy coatings on LiFePO₄ significantly enhanced discharge capacity, reaching 105.6 mAh/g at 1 C and 153 mAh/g at 0.2 C, respectively. Additionally, during the sintering process, PPy functions as a reducing agent, mitigating Fe³⁺ presence and stabilizing Fe²⁺ in the LFP structure.

Despite these advancements, existing solutions present significant trade-offs. While carbon coatings and conductive additives improve electrical conductivity, they also increase cell volume due to the low tap density of carbon materials. This results in a lower volumetric and gravimetric energy density, which is undesirable for compact, high-performance energy storage applications. Moreover, conventional methods of applying carbon layers onto the electrode or integrating carbon as a conductive diluent often fail to achieve an optimal balance between lithium-ion diffusion pathways and volumetric efficiency. The addition of carbon enhances electrical conductivity, power, and discharge rate, but the large volume occupied by carbon particles is a drawback for battery designs requiring compact and efficient energy storage.

US20190157681A1, titled “Cathode Slurry for Lithium-Ion Battery,” discloses a cathode slurry comprising a cathode active material, a conductive agent, a binder material, and a solvent. The cathode active material has a particle size D50 ranging from about 10 μm to about 50 μm, and the slurry, when coated onto a current collector with a wet film thickness of approximately 100 μm, has a drying time of about 5 minutes or less under controlled conditions of 60 °C to 90 °C and relative humidity between 25% and 40%. The cathode active material constitutes between 30% and 65% by weight, while the conductive agent accounts for only 0.8% to 5% by weight. This limited percentage of conductive agent in the prior art results in low lithium-ion diffusion pathways, which remains a critical barrier to achieving high-performance lithium-ion cells.

Although raw LFP has moderate lithium-ion diffusion pathways, it's very low electrical conductivity remains a key constraint. Therefore, there is a pressing need to develop an improved cathode formulation that enhances both lithium-ion diffusion pathways and electrical conductivity while maintaining minimal volume expansion. A novel approach that optimally incorporates conductive elements into LFP, ensuring increased electrical conductivity, high power output, and superior discharge rates without significantly increasing the overall cell volume, is essential to overcoming the limitations of current techniques and advancing lithium-ion battery technology.

### OBJECT OF THE INVENTION

An object of the present invention is to develop an improved method for manufacturing lithium iron phosphate (LFP) based lithium-ion cells that enhances lithium-ion diffusion pathways while maintaining a low overall cell volume.

Another object of the invention is to optimize the incorporation of conductive materials in the cathode structure to improve charge transfer efficiency without significantly increasing the weight or volume of the cell.

Yet another object of the invention is to overcome the limitations of prior art methods, such as those disclosed in US Patent Application No. US20190157681A1, where the low proportion of conductive agents results in poor lithium-ion diffusion pathways, while excessive use of carbon-based additives compromises energy density and increases cell volume.

A further object of the invention is to provide a cathode configuration that has a high electrical conductivity by including carbon as a conductive additive with the cathode active material and accordingly results in a high-rate discharge performance without adversely affecting the volumetric density of the lithium-ion cell.

It is also an object of the invention to achieve a manufacturing process that ensures uniform coating and controlled particle size distribution of the active material, thereby improving electrochemical performance while maintaining cost efficiency and scalability.

By achieving these objectives, the invention aims to address the dual challenges of maximizing energy storage and optimizing lithium-ion diffusion pathways and electrical conductivity for next-generation lithium iron cells.

### SUMMARY

The following summary is illustrative only and is not intended to be in any way limiting. In addition to the illustrative aspects, example embodiments, and features described, further aspects, example embodiments, and features, will become apparent by reference to the drawings and the following detailed description.

The present invention relates to an improved lithium-ion cell with enhanced electrochemical performance, higher energy density, improved cycle life, and better lithium-ion diffusion pathways. The invention specifically discloses novel anode and cathode compositions, their manufacturing methods, and electrolyte formulations that contribute to increased efficiency and longevity of lithium-ion batteries.

The anode of the lithium-ion cell comprises a mixture of graphite, and silicon or hard carbon or a combination of silicon and hard carbon, with graphite making up 80-95% by weight, while silicon and hard carbon are present in the range of 5-20% by weight, alone or in combination. For example, the anode can comprise 85% of graphite and 15% of silicon. In another example, the anode can comprise 89% of graphite and 11% of hard carbon. In yet another example, the anode can comprise 90% of graphite, and a combination of 5% of silicon and 5% of hard carbon. To enhance conductivity, conductive diluents such as single-walled carbon nanotubes, Super P, Super C65, and polyacrylic acid (PAA) are incorporated in an amount of 2-4% by weight. The anode also includes binders, which are selected from a range of materials including polyvinylidene fluoride (PVDF), styrene-butadiene rubber (SBR), carboxymethyl cellulose (CMC), poly(vinyl butyral) (PVB), polytetrafluoroethylene (PTFE), polyvinyl alcohol (PVA), perfluorosulfonic acid polymer, polyimide (PI), poly(methyl methacrylate) (PMMA), ethylene propylene diene monomer (EPDM), polyethylene oxide (PEO), polyurethane (PU), and latex-based binders in combination with CMC or SBR, in a proportion of 4-8% by weight. The anode slurry, which also contains a solvent in the range of 40-55% by weight, is coated onto a copper foil substrate and dried at a temperature ranging from 40-120 °C. A loading level of the anode is up to 32mg/cm².

In an embodiment, the cathode of the lithium-ion cell is composed of an active material composite. The active material composite is prepared by combining or mixing 80 to 95% by weight of a cathode active material with 5 to 20% by weight of a carbon based conductive material by a ball milling process. The cathode active material is selected from a lithium iron phosphate (LFP), lithium iron oxide (LiFeO₂), or lithium iron fluorophosphate (LiFePO₄). The carbon-based conductive material includes one or more of single-walled carbon nanotubes (SWCNTs), multi-walled carbon nanotubes (MWCNTs), graphene, carbon nanofibers (CNFs), activated carbon, Super P, conducting carbon, porous carbon, hard carbon, soft carbon, amorphous carbon, Ketjen black, vapor-grown carbon fibers (VGCFs), carbon black, carbon onions, mesoporous carbon, fullerene-derived carbon, polyaniline (PANI), or polypyrrole (PPy).

The active material composite is further crushed and combined with one or more of binders, conductive diluents and a solvent, to form a cathode slurry. The binders are added in a range of 3 to 8% by weight, the conductive diluents are added in the range of 2-4% by weight, and the solvent in a range of 40 to 55% by weight to the active material composite, in order to improve conductivity. Typically, the binders are selected from PVDF, SBR, CMC, acrylonitrile-based binders, PEO, PAA, and 5130 solvate. The conductive diluents are selected from SWCNT (single walled carbon nanotubes), Super P, Multi-Walled Carbon Nanotubes (MWCNT), graphene, carbon nanofibers (CNFs), activated carbon, conducting carbon, porous carbon, and ketjen black.

The cathode slurry is prepared by combining the active material composite with one or more of the conductive diluents, the binders, and the solvent, and is then coated onto a porous current collector. In an embodiment, where the binders are not utilized, the cathode slurry is formed from the combination of active material composite, the conductive diluents and the solvent.

The coated cathode material is subsequently dried at 40-120 °C and calendared to achieve a pore density ranging from 30-75%. The cathode active material concentration in the slurry is maintained between 90-94%. The loading level of the cathode is up to 30 mg/cm².

In an embodiment, to enhance conductivity, the cathode active material undergoes a carbon coating process, which may involve nanocoating. The nanocoating process is conducted in a vacuum environment at a temperature between 8-60 °C, followed by heat treatment at 600-800 °C. In another embodiment, the cathode active material is combined with the carbon based conductive materials by the ball milling process, which involves mixing the cathode active material with the carbon based conductive materials in a ball mill, at speeds ranging from 1500-2500 rpm, ensuring a uniform active material composite with a particle size ranging between 2 to 6 micrometres.

The electrolyte formulation of the lithium-ion cell includes a primary lithium salt, such as Lithium Bis(fluorosulfonyl)imide (LiFSI) or Lithium Hexafluorophosphate (LiPF₆). The formulation also incorporates various additives to enhance lithium-ion diffusion pathways, stabilize the Solid Electrolyte Interphase (SEI) layer, and improve cycling performance. These additives include Fluoroethylene Carbonate (FEC) in the range of 2-5% by weight, Vinylene Carbonate (VC) in the range of 0.5-3% by weight, Lithium Bis(oxalato)borate (LiBOB) in the range of 0.5-2% by weight, and Prop-1-ene-1,3-sultone (PES) in the range of 0.3-1% by weight. The optimized electrolyte composition contributes to an increase in lithium-ion diffusion pathways and electrical conductivity compared to conventional anode active materials.

The complete lithium-ion cell structure consists of an anode, a cathode, an electrolyte, and a separator positioned between the electrodes to facilitate ion transport. The cell is designed to achieve an energy density of at least 140 Wh/kg and is capable of delivering a maximum discharge pulse rate of up to 10 C, supporting continuous discharge at 5 C, and allowing fast charging at a rate of 4 C. The lithium-ion cell provides a capacity of 20 Ah with a cycle life exceeding 3000 cycles.

The invention also discloses a detailed method for preparing the anode and cathode components. The anode slurry is prepared by mixing the active material with conductive diluents, binders, and solvents, followed by coating the mixture onto a conductive foil and drying it. The cathode preparation involves combining the cathode active material using nanocoating, spray drying, or ball milling, and then mixing it with conductive diluents, binders, and solvents to form a cathode slurry. The cathode slurry is coated onto a current collector, dried, and calendared to the desired thickness. Environmental conditions during the cathode preparation process are carefully controlled, with humidity levels maintained below 1.0% to ensure optimal electrode performance.

The advanced material selection and processing techniques disclosed in the present invention result in improved structural stability, higher conductivity, longer cycle life, and better thermal stability compared to conventional lithium-ion battery designs. The improved lithium-ion cell offers significant advantages for energy storage applications, particularly in electric vehicles, portable electronics, and renewable energy storage systems, where high power, including high discharge, fast charging capabilities, high energy density, and extended cycle life are critical.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 illustrates a schematic view of a lithium-ion cell including a high-performance cathode and an anode, according to an example embodiment; and FIG. 2 is flowchart illustrating a method of manufacturing the lithium-ion cell, according to an example embodiment.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Similarly, like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any, and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, elements, and/or components, but do not preclude the presence or addition of one or more other features, integers, steps, operations, elements, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skills in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in ‘addition to the orientation depicted in the figures. For example, if the device in the figures is turned over, elements described as “below”, or “beneath” other elements or features would then be oriented “above” the other elements or features. Thus, term such as “below” may encompass both an orientation of above and below. The device may be otherwise oriented (rotated 90 degrees or at other orientations) and the spatially relative descriptors used herein are interpreted accordingly.

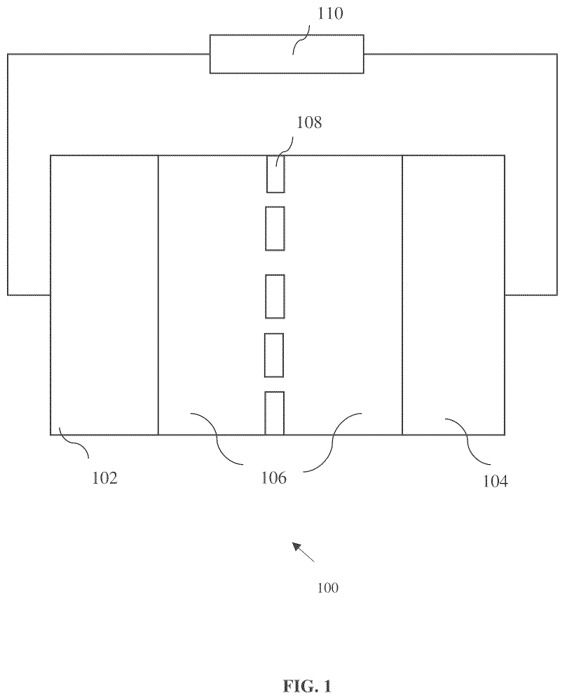

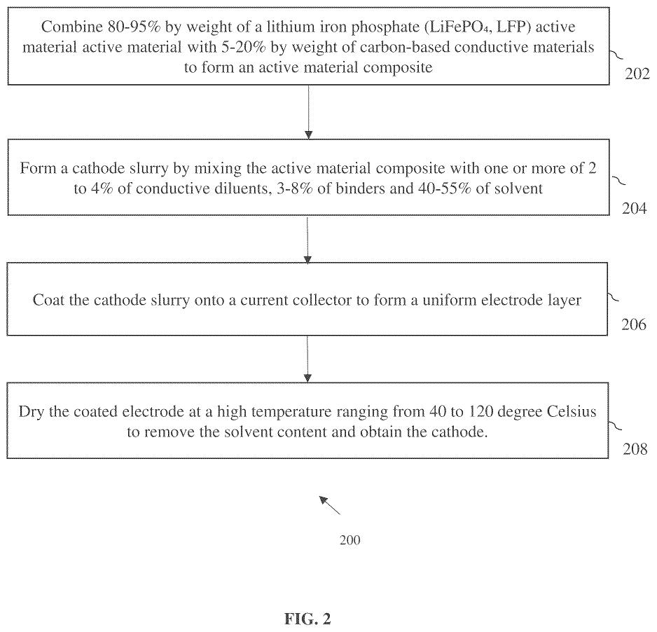

FIG. 1 illustrates a schematic view of a lithium-ion cell 100, according to an example embodiment. As shown, the lithium-ion cell 100 includes a cathode 102, an anode 104, an electrolyte 106, and a separator 108. The lithium-ion cell 100 is connected to an external load 110.

Typically, the cathode 102 includes, an active material composite composed of a cathode active material and carbon based conductive material, where the cathode active material in an embodiment, is a lithium iron phosphate (LFP) material, Lithium Iron Oxide (LiFeO2), Lithium Iron Fluorophosphate (LiFePO4), Lithium Iron Phosphate (LFP) or combination thereof, and the carbon based conductive material is one of single-walled carbon nanotubes (SWCNTs), multi-walled carbon nanotubes (MWCNTs), graphene, carbon nanofibers (CNFs), activated carbon, Super P, conducting carbon, porous carbon, hard carbon, soft carbon, amorphous carbon, Ketjen black, vapor-grown carbon fibers (VGCFs), carbon black, carbon onions, mesoporous carbon, fullerene-derived carbon, and conductive polymers such as polyaniline (PANI) and polypyrrole (PPy). In an embodiment, the active material composite includes the cathode active material in a ratio of 80 to 95% by weight and the carbon based conductive material in a ratio of 5 to 20% by weight. Typically, the active material composite is prepared by subjecting the cathode active material and the carbon based conductive materials to either spray drying, nanocoating, ball milling or a combination thereof in a vacuum environment at room temperatures and at a humidity level less than 5%. In an embodiment, the humidity level is maintained at less than 1% when the active material composite is prepared by the ball milling process. Further, depending on the location of manufacture, the room temperature can vary from 8 to 60 degree Celsius.

Maintaining low humidity levels (≤1%) and maintaining a vacuum-controlled environment during the processing of the active material composite is crucial for multiple reasons. An advantage of having less humidity (≤1%) in the preparation of the active material composite is prevention of formation of Lithium Hydroxide (LiOH) and Lithium Carbonate (Li₂CO₃). Generally, lithium-based cathode materials are highly hygroscopic, and hence they readily absorb moisture from the environment. Exposure to humidity leads to the formation of undesired LiOH and Li₂CO₃ layers on the cathode surface, which increases cell impedance and degrades performance. Low humidity prevents these side reactions, ensuring better electrochemical stability.

Another advantage of having low humidity (of less than 5% and 1% preferably) is reduced gas generation during battery operation, thereby preventing swelling and capacity loss. Further, a dry environment ensures that the cathode retains higher lithium-ion diffusion pathways leading to better charge-discharge efficiency. In process like spray drying, nanocoating or ball milling, low humidity helps in forming a uniform carbon coating on LFP particles. Uniform coatings improve electron transport and enhance the rate capability of the battery. Excess moisture leads to electrolyte degradation and cathode structure breakdown over repeated charge-discharge cycles. By maintaining humidity below 1%, the composite material remains more structurally stable, thereby increasing battery longevity.

Furthermore, high moisture content causes particle agglomeration, leading to uneven particle size distribution. Maintaining low humidity ensures consistent particle size, which improves packing density and energy efficiency. Hence, a controlled vacuum environment with <1% humidity is essential for producing a high-quality LFP active material composite with superior electrochemical properties, better cycling performance, and higher energy efficiency. This results in longer battery life, lower internal resistance, and improved safety, making it a key factor in advanced lithium-ion battery manufacturing.

In an example, during nanocoating, the cathode active material is combined with the carbon-based conductive material and is subjected to a heat treatment at a temperature ranging from 600 to 800 degree Celsius. For the ball milling process, the cathode active material and the carbon-based conductive material are mixed in the ball mill and subjected to rotation at a speed ranging from 1500 to 2500 rotations per minute (rpm), to obtain the active material composite. In an example, an LFP material is mixed with a carbon-based conductive material, such as blended carbon, via the ball milling process, to achieve the active material composite having a particle size D50 in a range from 2 to 6 micrometers. The particle size is much smaller than existing prior art solutions. In existing prior art, the cathode active material has a particle size D50 ranging from 6 to 50 micrometers, however the present disclosure achieves a much smaller particle size of 2 to 6 micrometers of the active material composite.

The present invention leverages the advantage of utilizing an LFP material with a carbon coating, processed through a ball milling technique, to achieve a particle size D50 in the range of 2 to 6 micrometers. In lithium iron phosphate (LFP) batteries, it is essential to achieve the appropriate particle size for the cathode material, as it significantly influences electrochemical performance. Traditionally, reducing particle size has been employed to shorten lithium-ion diffusion paths, thereby enhancing charge and discharge rates. However, this approach increases surface area, which reduces volumetric capacity due to poor packing efficiency. Conversely, increasing the size of LFP particles reduces power output due to its impact on porosity. To achieve an optimal balance, both carbon and LFP particle sizes must be carefully selected to prevent any volume disadvantage while maintaining the right level of porosity. This ensures efficient ion transport and overall battery performance without compromising capacity or conductivity.

Unlike conventional solutions where the cathode active material typically has a D 50 ranging from 2 to 50 micrometers, the present disclosure results in a significantly different particle size of the active material composite. This disclosed particle size of the active material composite, which is 2 to 6 micrometers, enhances both energy and power density by reducing electrolyte reactivity, improving electrode stability, and facilitating efficient electron and ion transport. These benefits enable faster charge-discharge cycles while maintaining high-capacity retention. Additionally, the optimized particle size contributes to achieving a higher volumetric energy density by enabling a denser and more uniform electrode packing, effectively reducing the overall cell volume while maintaining superior electrochemical performance.

The active material composite is then mixed with one or more binders, conductive diluents, and a solvent to form a cathode slurry. In an embodiment, the binders are in a ratio of 3 to 8% by weight, the conductive diluents are 2 to 4% by weight, and the solvent is 40 to 55% by weight. Other embodiments, and ratios are also envisaged in this disclosure. The binders are selected from Polyvinylidene Fluoride (PVDF), Styrene-Butadiene Rubber (SBR), Carboxymethyl Cellulose (CMC), Acrylonitrile-based binders, Polyethylene Oxide (PEO), Polyacrylic Acid (PAA) and 5130 solvate. The conductive diluents are selected from SWCNT (single walled carbon nanotubes) SWCNT (single walled carbon nanotubes), Super P, Multi-Walled Carbon Nanotubes (MWCNT), graphene, carbon nanofibers (CNFs), activated carbon, conducting carbon, porous carbon, and ketjen black. Depending on the ratios and concentrations, the cathode slurry has a viscosity ranging from 2500 to 6000 m. Pas. The cathode slurry is then coated on a porous current collector and is dried at a temperature ranging from 40-120 °C. Post drying, the cathode is calendared to achieve a pore density ranging from 30 to 75%. Typically, a concentration of the cathode active material in the cathode slurry is 90-94%, and a loading level of the cathode is maintained up to 30 mg/cm².

In an example, the cathode active material composite is prepared by mixing 92% by weight of lithium iron phosphate (LFP) with 8% by weight of carbon black in a ball mill rotating at 1000 rpm under a vacuum-controlled atmosphere and maintained at a temperature of 25 °C. The ball milling process is carried out for 2.5 hours to ensure uniform dispersion of the conductive carbon throughout the LFP particles, enhancing electrical conductivity and charge transfer efficiency. The vacuum-controlled atmosphere ensures a well-mixed composite, as the absence of air influences how the carbon adheres to the LFP particles. Following this, the mixture is blended with a solvent, such as N-methyl-2-pyrrolidone (NMP), along with 4% conductive diluents and 6% polyvinylidene fluoride (PVDF) binder to form a stable cathode slurry. In an embodiment, the cathode slurry is coated onto an aluminum current collector using a doctor blade technique, to achieve a uniform electrode layer with a controlled thickness of 100 μm. The coated electrode is subsequently dried at 80 °C in a vacuum oven for one hour to remove solvent residues and ensure strong adhesion between the active material and the current collector. The resulting cathode (102) exhibits enhanced structural integrity and electrochemical performance, making it suitable for high-energy-density lithium-ion battery applications.

The anode (104) further includes an anode active material comprising 80-95% by weight of graphite, and one or more of 5 to 20 % by weight of silicon, and 5 to 20% by weight of hard carbon. In an example, the anode active material comprises 80% by weight of graphite and 20% by weight of silicon. In another example, the anode active material includes 90% of silicon, 6% of graphite and 4% of hard carbon. Accordingly, various combinations of silicon with graphite and hard carbon individually and in combination can be envisaged. The anode (104) of the present invention is designed to optimize energy density, charge-discharge rates, and structural stability by incorporating a strategic combination of graphite, silicon, and hard carbon. Graphite, which constitutes 80-95% of the anode active material, serves as the primary component due to its stable intercalation mechanism and long cycle life. However, to enhance performance, the anode further includes 5-20% by weight of silicon and 5-20% by weight of hard carbon, each contributing unique advantages.

The inclusion of silicon significantly increases energy density, as silicon has a theoretical capacity of approximately 3579 mAh/g, nearly ten times higher than graphite's 372 mAh/g. By incorporating up to 20% silicon, the anode benefits from enhanced specific capacity while mitigating the extreme volume expansion (around 300%) that pure silicon undergoes during lithiation. This controlled composition ensures that the battery achieves higher energy storage without rapid degradation.

In addition to silicon, hard carbon is introduced into the anode structure to improve charge-discharge characteristics. Hard carbon possesses high porosity and low voltage hysteresis, allowing for rapid lithium intercalation, which enhances the battery's fast-charging capability. This property is particularly advantageous in applications that require high power output and quick energy replenishment, such as electric vehicles. The combination of hard carbon with graphite ensures better rate capability and reduces the risk of lithium plating at high charge rates, thereby improving the overall lifespan of the battery.

By combining graphite, silicon, and hard carbon in varying proportions, the present invention achieves a well-balanced anode configuration that offers both high energy density and superior power delivery. For instance, a composition of 80% graphite and 20% silicon significantly enhances energy storage, while alternative formulations, such as 80% graphite, 10% silicon, and 10% hard carbon, provide an optimal balance of energy density, fast charging, fast discharging and stability. This engineered anode composition ensures that lithium-ion batteries can deliver high performance, long cycle life, and enhanced charge-discharge efficiency, making them ideal for advanced applications such as electric vehicles, consumer electronics, and energy storage systems.

The anode active material is further combined with conductive diluents in a range of 2 to 4 % by weight or binders in a range of 4 to 8% by weight or a combination of both conductive diluents and binders. The composition is further dissolved in a solvent in a ratio of 40 to 55% by weight. Typically, the anode active material, the binders, the conductive diluents and the solvent are mixed to form an anode slurry, and the anode slurry is coated onto a conductive foil substrate to form the anode. The conductive diluents include one or more of a single walled carbon nanotubes, Super P, Super C65, and Poly Acrylic Acid (PAA). The binders include polyvinylidene fluoride (PVDF), styrene-butadiene rubber (SBR), and carboxymethyl cellulose (CMC), Poly(vinyl butyral) (PVB), Polytetrafluoroethylene (PTFE), Polyvinyl Alcohol (PVA), perfluorosulfonic acid polymer, Polyimide (PI), poly(methyl methacrylate) (PMMA), Ethylene Propylene Diene Monomer (EPDM), Polyethylene Oxide (PEO), Polyurethane (PU), Polytetrafluoroethylene (PTFE), Poly(vinyl butyral) (PVB), and latex-based binders in combination with CMC or SBR.

The anode slurry is coated on a conductive foil (e.g. a copper foil) at a temperature ranging from 40 to 120-degree Celsius. In an embodiment, a gradient temperature is provided to the coated anode. The coated anode is then dried to form the anode (104). The anode (104) is then integrated with the lithium-based cathode (102) and an electrolyte to form the lithium-ion cell (100). A separator (108) is positioned between the anode (104) and the cathode (102), and an electrolyte (106) is provisioned to be in ionic contact with the anode (104) and the cathode (102). The electrolyte (106) is a unique composition that includes at least one of Lithium Bis(fluorosulfonyl)imide (LiFSI) and Lithium Hexafluorophosphate (LiPF6) as the primary lithium salt and includes one or more additives selected from Fluoroethylene Carbonate (FEC) in an amount of 2-5% by weight, Vinylene Carbonate (VC) in an amount of 0.5-3% by weight, Lithium Bis(oxalato)borate (LiBOB) in an amount of 0.5-2% by weight, and Prop-1-ene-1,3-sultone (PES) in an amount of 0.3-1% by weight. The one or more additives enhance lithium-ion diffusion pathways, Solid Electrolyte Interphase (SEI) layer stability, and cycling performance of the lithium-ion cell. The electrolyte formulation primarily consists of LiFSI as the main salt, with alternatives like LiPF6. Various additives are incorporated to enhance battery performance and longevity. Fluoroethylene carbonate (FEC) (2-5%) stabilizes the solid electrolyte interphase (SEI), minimizes silicon expansion, and prevents electrolyte decomposition in graphite anodes. Vinylene carbonate (VC) (0.5-3%) strengthens the SEI layer, preventing cracks and gassing while maintaining electrolyte integrity. Lithium bis(oxalato)borate (LiBOB) (0.5-2%) enhances SEI formation for fast charging, improves anode stability, and supports long cycle life. Prop-1-ene-1,3-sultone (PES) (0.3-1%) improves SEI compactness and reduces irreversible capacity loss, further contributing to battery efficiency.

This electrolyte composition provides high lithium-ion diffusion pathways (8-12 mS/cm), optimizing Li-ion transport pathways for better performance. The inclusion of a ceramic-coated separator improves thermal stability and enhances ion transport efficiency, enabling high-density stacking within the cell. Additionally, the tailored surface area interactions between the electrode and electrolyte contribute to enhanced charge retention, cycle life, and thermal safety, making it well-suited for high-performance lithium-ion battery applications.

The disclosed lithium-ion cell (100), incorporating the specified cathode material, demonstrates a high energy density of at least 140 Wh/kg. Energy density is a critical parameter that defines the amount of energy a battery can store per unit weight, directly impacting the battery's overall efficiency and performance. A higher energy density enables the design of more compact and lightweight battery packs without sacrificing capacity, which is particularly beneficial for applications requiring reduced form factors, such as electric vehicles (EVs), portable electronics, and aerospace applications.

The lithium-ion cell (100) supports a peak discharge pulse rate of up to 10 C, meaning it can deliver ten times its rated capacity in a short burst. This characteristic is essential for high-power applications where sudden surges in energy demand occur, such as acceleration in EVs or power tools. Additionally, the ability to sustain a continuous discharge at 5 C ensures that the battery maintains high performance under prolonged load conditions, preventing thermal and capacity degradation.

Fast charging at a rate of 4 C further enhances the cell's usability by significantly reducing charging times. For instance, a 20 Ah cell charged at 4 C would reach full capacity in approximately 15 minutes, making it suitable for applications that require rapid energy replenishment, such as electric fleets or grid energy storage systems.

By achieving a cycle life exceeding 3000 cycles, the battery remains operational for extended periods before requiring replacement, reducing maintenance costs and waste. This longevity, combined with high energy density and optimized charge-discharge rates, allows for a reduction in overall battery size while maintaining or even improving performance.

For example, in electric vehicles (EVs) a more efficient LFP cell with a higher discharge rate means fewer cells are needed to deliver the required power, leading to a smaller and lighter battery pack, ultimately reducing vehicle weight and improving range. Further, in consumer electronics the improved charge and discharge efficiency enable thinner and lighter batteries in smartphones and laptops, allowing for sleeker designs without sacrificing battery life. Also, in Grid Storage and Industrial Applications a high cycle life and rapid charging enable a more compact battery design, reducing the footprint of energy storage systems while maintaining the ability to handle peak loads efficiently.

Thus, the disclosed battery technology directly contributes to minimizing the form factor of LFP cells by improving energy utilization, reducing the number of required cells, and enabling more compact and high-performance battery configurations.

The reduction in the form factor in the disclosed lithium-ion cell, can be ascertained further by comparing with conventional lithium-ion cell configurations. Consider a high-performance lithium-ion cell in a 1000 Ah 32 Volt battery pack. Assuming a conventional lithium-ion cell has a capacity of 10 Ah. To build a 1000 Ah, 32 V battery we would require a parallel configuration of 1000 Ah/10 Ah=100 cells in parallel. Assuming each cell operated at 3.2 V nominal, to achieve 32V, we need 10 cells in series (32 V/3.2 V=10). Hence total cells required is 100*10=1000 cells. This results in a very large form factor due to high number of cells.

However, with the disclosed lithium-ion cell having a capacity of 20 Ah, the number of cells required reduced significantly. By parallel configuration 1000 Ah/20 Ah=50 cells in parallel, and in series configuration 32 V/3.2V=10 cells in series. Total cells required is 50*10 =500 cells. By using the disclosed 20 Ah lithium-ion cell, the total number of cells required for the same 1000 Ah, 32V battery reduces from 1000 cells to 500 cells, resulting in a 50% reduction in form factor. This significantly improved battery pack efficiency, reduces weight, minimizes space requirements and enhances overall system integration in applications, like electric vehicles energy storage, and industrial power solutions.

FIG. 2 is flowchart 200 illustrating a method of manufacturing the cathode of the disclosed lithium-ion cell, according to an example embodiment.

At step 202, a combining process is carried out in which 80-95% by weight of lithium iron phosphate (LiFePO₄, LFP) active material is combined with 5-20% by weight of carbon-based conductive materials. This combination results in the formation of an active material composite. The combining can be done by spray drying, nanocoating or ball milling in a vacuum controlled environment and at room temperature.

The inclusion of carbon-based conductive materials ensures enhanced electrical conductivity, thereby facilitating efficient electron transfer within the cathode structure. For example, carbon black or graphene may be used as conductive additives to improve charge distribution, ultimately leading to better electrochemical performance.

At step 204, a cathode slurry is prepared by mixing the active material composite with 2-4% of conductive diluents, 3-8% of binders, and 40-55% of a solvent. The conductive diluents, such as carbon black or acetylene black, are incorporated to maintain a consistent electrical pathway across the electrode. Binders, such as polyvinylidene fluoride (PVDF) or styrene-butadiene rubber (SBR), ensure adhesion of the active material to the current collector, preventing structural degradation over multiple charge-discharge cycles. The solvent, which is typically N-methyl-2-pyrrolidone (NMP) or water, aids in achieving a homogenous slurry with optimal viscosity (e.g. 2500 to 6000 m, Pas) for uniform coating.

At 206, following the slurry preparation, the coating process is carried out, where the cathode slurry is uniformly applied onto a current collector, typically made of aluminium foil. This step is crucial for ensuring a well-distributed electrode layer, which affects the overall electrochemical performance of the lithium-ion cell. The coating thickness is carefully controlled to maintain an optimal balance between energy capacity and mechanical stability.

At 208, once coated, the electrode undergoes a drying process at a temperature ranging from 40 °C to 120 °C. This step facilitates the removal of solvent content, thereby solidifying the cathode structure and ensuring that the binder effectively secures the active material onto the current collector. The controlled drying conditions help prevent electrode cracking or delamination, which could otherwise impact battery performance and lifespan. For example, lower drying temperatures (~40 °C-60 °C) are often used for water-based binders, whereas higher temperatures (~80 °C-120 °C) are suitable for NMP-based formulations.

This meticulous drying process also ensures a more homogeneous distribution of pores within the electrode, which is critical for optimizing lithium-ion diffusion pathways and electronic conductivity during battery operation. By controlling a drying temperature and rate, the process avoids thermal degradation of sensitive materials, such as binders, conductive additives, or the active material itself, preserving the electrode's structural and electrochemical integrity. Disclosed drying thus plays a pivotal role in achieving the desired electrode thickness, porosity, and mechanical robustness, all of which contribute to the overall performance and longevity of the electrochemical cell.

These method steps collectively contribute to the fabrication of a high-performance LFP cathode with improved conductivity, structural stability, and electrochemical efficiency, making it suitable for use in lithium-ion battery applications requiring high power density and long cycle life. By addressing critical parameters such as material composition, viscosity control, drying techniques, and calendaring, this invention significantly enhances the efficiency, reliability, and longevity of lithium-ion cells. It represents a valuable breakthrough in battery technology, offering scalable solutions for next-generation energy storage systems and high-power applications.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in a different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the example embodiments described are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

1. (canceled)

2. (canceled)

3. (canceled)

4. (canceled)

5. A cathode (102) of a lithium-ion cell (100), the cathode (102) comprising:
a porous current collector coated with a cathode slurry,
wherein the cathode slurry is formed by mixing an active material composite with one or more of: 3-8% of binders, 2 to 4% of conductive diluents, and 40-55% of a solvent,
wherein the_active material composite comprises a cathode active material and a carbon-based conductive material, wherein the cathode active material is in a ratio of 80-95% by weight and the carbon-based conductive material is in a ratio of 5-20% by weight,
wherein the cathode active material is combined with the carbon-based conductive material using a ball milling process in a vacuum-controlled environment maintained at room temperature to form the active material composite, and
wherein during the ball milling process, the cathode active material and the carbon based conductive material are mixed in the ball mill and subjected to rotation at a speed of 1500 to 2500 rpm to obtain a carbon coating on the cathode active material and resulting in a particle size D50 in a range from 2 to 6 micrometers.

6. (canceled)

7. The cathode (102) of claim 5, wherein the cathode slurry has a viscosity ranging from 2500 mPa. s to 6000 mPa.s.

8. The cathode (102) of claim 5,
wherein the cathode active material is selected from a group consisting of Lithium Iron Oxide (LiFeO₂), Lithium Iron Fluorophosphate (LiFePO₄F), and Lithium Iron Phosphate (LFP); and
wherein the carbon-based conductive material includes one or more of single-walled carbon nanotubes (SWCNTs), multi-walled carbon nanotubes (MWCNTs), graphene, carbon nanofibers (CNFs), activated carbon, Super P, conducting carbon, porous carbon, hard carbon, soft carbon, amorphous carbon, Ketjen black, vapor-grown carbon fibers (VGCFs), carbon black, carbon onions, mesoporous carbon, fullerene-derived carbon, and conductive polymers such as polyaniline (PANI) and polypyrrole (PPy); and
wherein the binders are selected from Polyvinylidene Fluoride (PVDF), Styrene-Butadiene Rubber (SBR), Carboxymethyl Cellulose (CMC), Acrylonitrile-based binders, Polyethylene Oxide (PEO), Polyacrylic Acid (PAA) and 5130 solvate; and
wherein the conductive diluents are selected from SWCNT (single walled carbon nanotubes), Super P, Multi-Walled Carbon Nanotubes (MWCNT), graphene, carbon nanofibers (CNFs), activated carbon, conducting carbon, porous carbon, and ketjen black.

9. The cathode (102) of claim 5, wherein post coating on the current collector, the cathode slurry is dried at 40-120 °C to achieve a pore density ranging from 30 to 75%; wherein the cathode active material contributed 90-94% of the cathode slurry; and wherein a loading level of the cathode is maintained up to 30 mg/cm².

10. The cathode (102) of claim 5, wherein the lithium cell (100) includes:
an anode (104) comprising:
an anode active material comprising 80-95% by weight of graphite, and one or more of 5-20% by weight of silicon, and 5-20% of hard carbon;
one or more conductive diluents in a range of 2 to 4% by weight and binders in a range of 4 to 8% by weight; and
a solvent comprising 40-55% by weight;
a separator (108) positioned between the anode and the cathode; and
an electrolyte (106) in ionic contact with the anode and the cathode, wherein the electrolyte comprises at least one of Lithium Bis(fluorosulfonyl)imide (LiFSI) and Lithium Hexafluorophosphate (LiPF6) as the primary lithium salt and includes one or more additives selected from Fluoroethylene Carbonate (FEC) in an amount of 2-5% by weight, Vinylene Carbonate (VC) in an amount of 0.5-3% by weight, Lithium Bis(oxalato)borate (LiBOB) in an amount of 0.5-2% by weight, and Prop-1-ene-1,3-sultone (PES) in an amount of 0.3-1% by weight, and wherein the one or more additives enhance lithium-ion diffusion pathways, Solid Electrolyte Interphase (SEI) layer stability, and cycling performance of the lithium-ion cell.

11. The cathode (102) of claim 5, wherein the lithium-ion cell (100) incorporating the cathode achieves an energy density of at least 140 Wh/kg, supports a maximum discharge pulse rate of up to 10 C, enables continuous discharge of 5 C, and allows for fast charging at a rate of 4 C, and wherein the lithium-ion cell is capable of delivering a capacity of 20 Ah, with a cycle life exceeding 3000 cycles.

12. A lithium-ion cell (100) comprising:
a cathode (102) comprising:
a porous current collector coated with a cathode slurry,
wherein the cathode slurry is formed by mixing an active material composite with one or more of: 3-8% of binders, 2-4% of conductive diluents, and 40-55% of a solvent,
wherein the active material composite comprises lithium iron phosphate (LFP) active material and carbon-based conductive materials, wherein the LFP active material is in a ratio of 80-95% by weight and the carbon-based conductive materials is in a ratio of 5-20% by weight,
and
wherein the cathode-LFP active material is combined with the carbon-based conductive materials using a ball milling process in a vacuum-controlled environment maintained at room temperature to form the active material composite, and
wherein during the ball milling process, the LFP active material and the carbon based conductive materials are mixed in the ball mill and subjected to rotation at a speed of 1500 to 2500 rpm to obtain a carbon coating on the LFP active material and resulting in a particle size D50 in a range from 2 to 6 micrometers; and
an anode (104) comprising:
a conductive foil substrate coated with an anode slurry,
wherein the anode slurry is formed by mixing an anode active material with one or more of: conductive diluents, binders and a solvent,
wherein the anode active material comprising comprise 80-95% by weight of graphite, and one or more of 5-20% by weight of silicon, and 5-20% by weight of hard carbon,
wherein the one or more conductive diluents are in a range of 2 to 4% and the binders are in a range of 4 to 8% by weight, and
wherein the solvent is in a range of 40-55% by weight;
a separator (108) positioned between the cathode and the anode to facilitate ion transport; and
an electrolyte (106) in contact with the cathode and the anode, wherein the electrolyte comprises a lithium salt combined with additives to facilitate lithium-ion transport within the cell.

13. The lithium-ion cell (100) of claim 12, wherein the electrolyte (106) comprises Lithium Bis(fluorosulfonyl)imide (LiFSI) as the primary lithium salt and includes one or more additives selected from Fluoroethylene Carbonate (FEC) in an amount of 2-5% by weight, Vinylene Carbonate (VC) in an amount of 0.5-3% by weight, Lithium Bis(oxalato)borate (LiBOB) in an amount of 0.5-2% by weight, and Prop-1-ene-1,3-sultone (PES) in an amount of 0.3-1% by weight, and wherein the one or more additives enhance lithium-ion diffusion pathways, Solid Electrolyte Interphase (SEI) layer stability, and cycling performance of the lithium-ion cell.

14. The lithium-ion cell (100) of claim 12,
wherein the lithium iron phosphate (LFP) active material is combined with carbon-based conductive materials in a controlled environment having a humidity less than 5.0%.

15. (canceled)

16. (canceled)

17. (canceled)

18. (canceled)

19. (canceled)

20. The cathode (102) of claim 5, wherein the vacuum-controlled environment is maintained at a humidity of less than or equal to 1% during the ball milling process.

21. The cathode (102) of claim 5, wherein the active material composite is formed as a discrete step prior to forming the cathode slurry, and wherein the carbon-based conductive material is uniformly dispersed on the cathode active material particles in the vacuum-controlled environment.

22. The cathode (102) of claim 10, wherein the separator (108) is a ceramic-coated separator, and wherein the porous current collector comprises an aluminum current collector.

23. The cathode (102) of claim 5, wherein the room temperature is in a range of 8 to 60 °C.
